(19) United States
(12) Patent Application Publication
(10) Pub. No.: US 2008/0082610 A1
(43) Pub. Date: Apr. 3, 2008

(54) Method and apparatus for providing collaborative user interface feedback

(76) Inventors: Devin W. Breise, La Jolla, CA (US); Marie Tahir, San Diego, CA (US)

Correspondence Address: INTUIT, INC.;c/o PARK, VAUGHAN & FLEMING LLP, 2820 FIFTH STREET, DAVIS, CA, 95618-7759, US

(21) Appl. No.: 11/540,355

(22) Filed: Sep. 29, 2006

(51) Int. Cl. G06F 15/16

(52) U.S. Cl. 709/204

(57) ABSTRACT

One embodiment of the present invention provides a system that facilitates providing collaborative User Interface (UI) feedback. The system is designed to aid a programmer in structuring a UI to improve the user's experience. The system operates by receiving a command from a user while the user is using an application in a normal executing mode, wherein the command instructs the application to enter a UI annotation mode. In response to the command, the system enters the UI annotation mode. While in the UI annotation mode, the system receives annotations from the user, wherein the annotations are associated with elements of the UI. The system then sends the annotations to a centralized repository, which consolidates annotations from multiple users.

### BACKGROUND

### Related Art

Application programmers are often faced with the complex problem of creating a User Interface (UI) that functions effectively for a large number of consumers that will use their applications. In many instances, application programmers are not familiar with the business processes of their clients, or their clients use the applications in a manner which is different from what the application programmer intended. Thus, creating a UI that functions effectively for a large number of users is a difficult task.

One way in which application programmers typically refine their UIs is through the use of customer focus groups and feedback mechanisms. These focus groups and feedback mechanisms provide feedback to the application programmer which helps the application programmer to tailor the UI to better meet their needs and expectations. However, these focus groups and feedback mechanisms typically have drawbacks. First, focus groups usually encompass a very small percentage of the user population. Most users decline to participate in the focus groups for various reasons.

Furthermore, many feedback mechanisms are not context-specific. Before describing a problem or suggesting a change to a UI, a user typically has to explain the context of the application. For example, a user might have to describe what process he or she is performing, and where they are in that process, in order to convey meaningful information about UI changes. This involves a tremendous amount of effort for the user, and in many cases, discourages the user from using the feedback mechanism.

Another problem with using focus groups is communicating complex ideas to the application programmer. If the feedback is simple, such as “move a button to the bottom of the screen,” it is very easy to communicate the idea to the application programmer. However, when dealing with a complex application with hundreds, or even thousands, of elements, it can be difficult for a user to communicate more involved ideas or design changes to the application programmer. In many cases, users simply do not want to take the time to convey these complex ideas.

Lack of collaboration is another problem with focus groups. In most cases, users typically report their comments and observations via a reporting mechanism, and the results are collected and provided to the application programmer. Users typically do not see what suggestions other users are making. This means that many users often make the same suggestions, which can waste time and resources of the programming staff. However, even more troubling is that many users make counter-suggestions. For example, some users may want a button moved to the left, while another group wants the button moved to the right. In this scenario, the application programmer is back to square one.

### SUMMARY

One embodiment of the present invention provides a system that facilitates providing collaborative User Interface (UI) feedback. The system is designed to aid a programmer in structuring a UI to improve the user's experience. The system operates by receiving a command from a user while the user is using an application in a normal executing mode, wherein the command instructs the application to enter a UI annotation mode. In response to the command, the system enters the UI annotation mode. While in the UI annotation mode, the system receives annotations from the user, wherein the annotations are associated with elements of the UI. The system then sends the annotations to a centralized repository, which consolidates annotations from multiple users.

In a variation on this embodiment, the system receives one or more annotations from the centralized repository. The system then displays the one or more annotations on the UI.

In a variation on this embodiment, if a client that is executing the application is not connected to a network, the system saves the annotation on the client. The system subsequently sends the annotation to the centralized repository when the client connects to the network.

In a variation on this embodiment, the user is a member of a group of users, and the centralized repository is associated with the group of users.

In a variation on this embodiment, the annotation can include a user note, a repositioning of the element of the UI, a modification to a property of the element of the UI, an input from a drawing tool, such as a digital pen or a mouse, a deletion of the element of the UI, and an addition of a new element to the UI.

In a variation on this embodiment, the annotation is associated with a group of elements in the UI.

In a variation on this embodiment, the system receives a command from the user at the application, wherein the command instructs the application to exit the UI annotation mode. In response to the command, the system exits the UI annotation mode and returns to the normal executing mode.

In a variation on this embodiment, entering the UI annotation mode further involves opening a collaborative chat interface wherein the user can chat with other users who are annotating instances of the same UI.

In a variation on this embodiment, the element of the UI can include at least one of a command button, a list box, a text box, a check box, a radio button, a drawing, a line, a picture, a window, a label, a pop-up window, a standard dialog, a modal dialog, a toolbar, a scrollbar, a task pane, a menu bar, and a menu item.

In a variation on this embodiment, the system receives a command from a programmer at the centralized repository, wherein the command instructs the centralized repository to send the annotation to the programmer. In response to the command, the system sends the annotation to the programmer.

### BRIEF DESCRIPTION OF THE FIGURES

FIG. 1 illustrates a collaborative UI annotation environment in accordance with an embodiment of the present invention.

FIG. 2 illustrates a UI in accordance with an embodiment of the present invention.

FIG. 3 presents a flow chart illustrating the process of collaborative UI annotation in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Overview

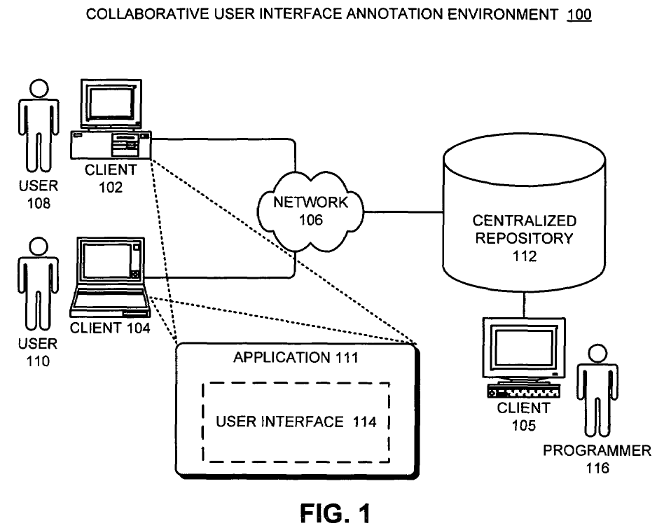

FIG. 1 illustrates a collaborative UI annotation environment 100 in accordance with an embodiment of the present invention. Collaborative UI annotation environment 100 includes clients 102, 104, and 105, network 106, users 108 and 110, centralized repository 112, and programmer 116. Clients 102 and 104 are both executing instances of application 111, and application 111 includes User Interface (UI) 114.

Clients 102 and 104 can generally include any node on a network including computational capability and including a mechanism for communicating across the network.

Network 106 can generally include any type of wired or wireless communication channel capable of coupling together computing nodes. This includes, but is not limited to, a local area network, a wide area network, or a combination of networks. In one embodiment of the present invention, network 106 includes the Internet.

Centralized repository 112 can include any type of system for storing data in non-volatile storage. This includes, but is not limited to, systems based upon magnetic, optical, or magneto-optical storage devices, as well as storage devices based on flash memory and/or battery-backed up memory.

One embodiment of the present invention provides a system that facilitates providing collaborative UI 114 feedback. The system is designed to aid a programmer 116 in structuring a UI 114 around improving the elements of the customer experience. The system operates by receiving a command from a user 108 at an application 111 while the user 108 is using the application 111 in a normal executing mode, wherein the command instructs the application 111 to enter a UI 114 annotation mode.

In response to the command, the system enters the UI 114 annotation mode. While in the UI 114 annotation mode, the system receives an annotation from the user 108, wherein the annotation is associated with an element of the UI 108. The system then sends the annotation to a centralized repository 112, wherein the centralized repository 112 consolidates annotations from multiple users, such as users 108 and 110.

Note that in one embodiment of the present invention, the application 111 is a standard user application, and is not a UI 114 development application. For example, application 111 may be an accounting program or a word processor that user 108 uses to perform tasks that are unrelated to the development of UI 114. Embodiments of the present invention enables programmer 116 to receive feedback from user 108 relating to UI 114 in a non-invasive manner while using application 111 for standard operations.

Since user 108 and user 110 are using the same application 111, as user 108 enters the UI 114 annotation mode, client 102 receives one or more annotations from the centralized repository 112 that were previously submitted by other users, such as user 110. The system then displays the one or more annotations on UI 114. This helps facilitate feedback to programmer 116 because user 108 would not need to make an annotation to UI 114 that user 110 has already made. Furthermore, if user 108 and user 110 have a difference of opinion on a specific annotation to UI 114, they can open a shared chat dialogue to discuss their differences, or add notes to their annotations explaining their reasons for the annotations to UI 114.

In one embodiment of the present invention, client 102 can keep a local cache of annotations to facilitate working offline when client 102 does not have a connection to network 106. While online, client 102 can periodically synchronize annotations with centralized repository 112.

In one embodiment of the present invention, annotations to UI 114 can include virtually any type of markup. This may include: a user note, a repositioning of the element of UI 114, a modification to a property of the element of UI 114, an input from a drawing tool, such as a digital pen or a mouse, a deletion of the element of UI 114, and an addition of a new element to UI 114. Furthermore, annotations can include a group of elements in UI 114. For example, a user 108 could circle a collection of elements in UI 114 and can add a note referencing the circled elements.

In one embodiment of the present invention, centralized repository 112 is a global repository for all instances of application 111. However, centralized repository 112 could also be specific to certain groups, such as an organization, a club, a business, or a specific type of users. Having different centralized repositories for different groups of users can be beneficial in situations where different groups of users want to drive the development of UI 114 in different directions.

Element of the UI 114 can include at least one of a command button, a list box, a text box, a check box, a radio button, a drawing, a line, a picture, a window, a label, a pop-up window, a standard dialog, a modal dialog, a toolbar, a scrollbar, a task pane, a menu bar, and a menu item. Note that the present invention is not meant to be limited to these items alone. This list of elements is presented as an example of the type of elements that can be annotated.

### Process of Collaborative UI Annotation

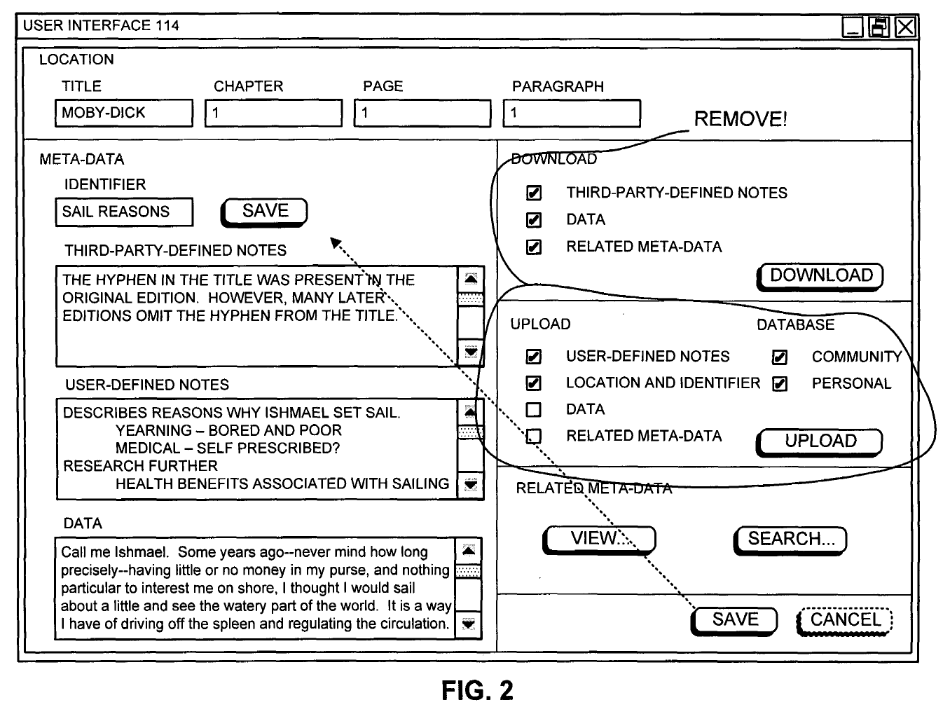

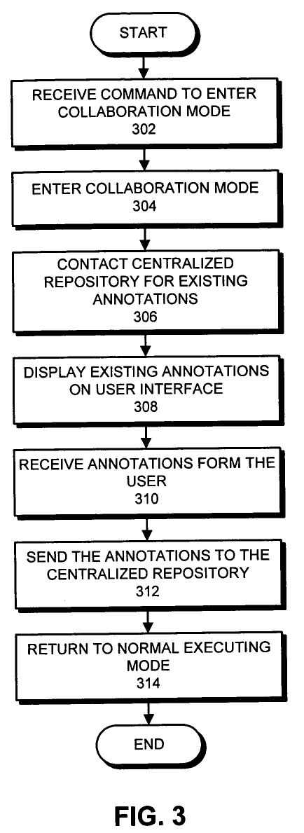

FIG. 2 illustrates a UI 114 and FIG. 3 presents a flow chart illustrating the process of collaborative UI 114 annotation in accordance with an embodiment of the present invention.

The system starts by receiving a command from user 108 to enter into an annotation mode while executing application 111 (step 302). In response to the command, the system enters the annotation mode (step 304) and contacts centralized repository 112 to obtain existing annotations to the current context in UI 114 (step 306). Note that if client 102 is working in offline mode, the system works with a local cache on client 102, and synchronizes the local cache with centralized repository 112 when a connection with centralized repository 112 is restored.

Once the annotations have been received at UI 114 from the centralized repository 112, the system displays the annotations on UI 114 for user 108 (step 308). For example, user 110 has previously circled the “upload” portion of UI 114 and has added a note to remove that section. The system then receives annotations to UI 114 from user 108 (step 310) and sends the annotations to centralized repository 112 (step 312).

For example, user 108 may drag the “save” button from the lower right to the upper left (illustrated with the dashed line) because he or she feels it is more appropriate in that area. Optionally, user 108 may add a note indicating why this annotation is appropriate. Note that these annotations can be new annotations, or they can be changes to existing annotations. For example, user 108 could modify the existing annotation created by user 110. In one embodiment of the present invention, the system can maintain a time-stamped history of annotations.

In one embodiment of the present invention, annotations may also include the addition of new elements, such as the “cancel” button in the lower right. Furthermore, user 108 may also remove elements rather than marking them for removal. Virtually any element that can be added to UI 114, deleted from UI 114, or changed in UI 114 can be annotated. Besides indicating location and presence, annotations can specify shape, size, orientation, color, etc. In one embodiment of the present invention, annotations can include sounds or other media. Furthermore, in one embodiment of the present invention, user 108 can attach a file to UI 114 for programmer 116.

When user 108 is done making annotations to UI 114, user 108 can leave the annotation mode and return to the normal execution mode by clicking a button or performing any other method suitable for informing application 111 to return to normal executing mode (step 314).

Programmer 116 can log into centralized repository 112 and collect the annotations to facilitate redesigned or improving UI 114. This helps programmer 116 to structure the UI around improving the elements of the customer experience.

Note that in one embodiment of the present invention, the collaborative UI annotation environment 100 is integrated into application 111 and user interface 114. In this embodiment, any user that has access to application 111 can use the collaborative UI annotation environment 100.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for providing collaborative User Interface (UI) feedback, comprising:
receiving a command from a user at an application while the user is using the application in a normal executing mode, wherein the command instructs the application to enter a UI annotation mode;
in response to the command, entering the UI annotation mode;
receiving an annotation from the user, wherein the annotation is associated with an element of the UI; and
sending the annotation to a centralized repository, wherein the centralized repository consolidates annotations from multiple users.

2. The method of claim 1, further comprising:
receiving one or more annotations from the centralized repository; and
displaying the one or more annotations on the UI.

3. The method of claim 1, wherein if a client that is executing the application is not connected to a network, sending the annotation to a centralized repository further involves:
saving the annotation on the client; and
sending the annotation to the centralized repository when the client connects to the network.

4. The method of claim 1, wherein the user is a member of a group of users, and wherein the centralized repository is associated with the group of users.

5. The method of claim 1, wherein the annotation can include:
a user note;
a repositioning of the element of the UI;
a modification to a property of the element of the UI;
an input from a drawing tool, such as a digital pen or a mouse;
a deletion of the element of the UI; and
an addition of a new element to the UI.

6. The method of claim 1, wherein the annotation is associated with a group of elements in the UI.

7. The method of claim 1, further comprising:
receiving a command from the user at the application, wherein the command instructs the application to exit the UI annotation mode; and
in response to the command, exiting the UI annotation mode and returning to the normal executing mode.

8. The method of claim 1, wherein entering the UI annotation mode further involves opening a collaborative chat interface wherein the user can chat with other users who are annotating instances of the same UI.

9. The method of claim 1, wherein the element of the UI can include at least one of:
a command button;
a list box;
a text box;
a check box;
a radio button;
a drawing;
a line;
a picture;
a window;
a label;
a pop-up window;
a standard dialog;
a modal dialog;
a toolbar;
a scrollbar;
a task pane;
a menu bar; and
a menu item.

10. The method of claim 1, further comprising:
receiving a command from a programmer at the centralized repository, wherein the command instructs the centralized repository to send the annotation to the programmer; and
in response to the command, sending the annotation to the programmer.

11. A computer-readable storage medium storing instructions that when executed by a computer cause the computer to perform a method for providing collaborative User Interface (UI) feedback, the method comprising:
receiving a command from a user at an application while the user is using the application in a normal executing mode, wherein the command instructs the application to enter a UI annotation mode;
in response to the command, entering the UI annotation mode;
receiving an annotation from the user, wherein the annotation is associated with an element of the UI; and
sending the annotation to a centralized repository, wherein the centralized repository consolidates annotations from multiple users.

12. The computer-readable storage medium of claim 11, wherein the method further comprises:
receiving one or more annotations from the centralized repository; and
displaying the one or more annotations on the UI.

13. The computer-readable storage medium of claim 11, wherein if a client that is executing the application is not connected to a network, sending the annotation to a centralized repository further involves:
saving the annotation on the client; and
sending the annotation to the centralized repository when the client connects to the network.

14. The computer-readable storage medium of claim 11, wherein the user is a member of a group of users, and wherein the centralized repository is associated with the group of users.

15. The computer-readable storage medium of claim 11, wherein the annotation can include:
a user note;
a repositioning of the element of the UI;
a modification to a property of the element of the UI;
an input from a drawing tool, such as a digital pen or a mouse;
a deletion of the element of the UI; and
an addition of a new element to the UI.

16. The computer-readable storage medium of claim 11, wherein the annotation is associated with a group of elements in the UI.

17. The computer-readable storage medium of claim 11, wherein the method further comprises:
receiving a command from the user at the application, wherein the command instructs the application to exit the UI annotation mode; and
in response to the command, exiting the UI annotation mode and returning to the normal executing mode.

18. The computer-readable storage medium of claim 11, wherein entering the UI annotation mode further involves opening a collaborative chat interface wherein the user can chat with other users who are annotating instances of the same Ul.

19. The computer-readable storage medium of claim 11, wherein the element of the UI can include at least one of:
a command button;
a list box;
a text box;
a check box;
a radio button;
a drawing;
a line;
a picture;
a window;
a label;
a pop-up window;
a standard dialog;
a modal dialog;
a toolbar;
a scrollbar;
a task pane;
a menu bar; and
a menu item.

20. The computer-readable storage medium of claim 11, wherein the method further comprises:
receiving a command from a programmer at the centralized repository, wherein the command instructs the centralized repository to send the annotation to the programmer; and
in response to the command, sending the annotation to the programmer.

21. An apparatus that provides collaborative User Interface (UI) feedback, comprising:
a receiving mechanism configured to receive a command from a user at an application while the user is using the application in a normal executing mode, wherein the command instructs the application to enter a UI annotation mode;
an annotation mechanism configured to enter the UI annotation mode in response to the command;
wherein the receiving mechanism is further configured to receive an annotation from the user, wherein the annotation is associated with an element of the UI; and
a sending mechanism configured to send the annotation to a centralized repository, wherein the centralized repository consolidates annotations from multiple users.

22. The apparatus of claim 21:
wherein the receiving mechanism is further configured to receive one or more annotations from the centralized repository; and
wherein the apparatus further comprises a display mechanism configured to display the one or more annotations on the UI.

23. A data structure embodied on a computer readable storage medium, wherein the data structure facilitates collaborative User Interface (UI) feedback, the data structure comprising:
an identifier for an element of a UI;
a property for the element of the UI;
a type for the element of the UI;
an annotation associated with the element of the UI; and
an identifier for a user that is associated with the annotation.

24. The data structure of claim 23, wherein the type for the element of the UI can include:
a command button;
a list box;
a text box;
a check box;
a radio button;
a drawing;
a line;
a picture;
a window;
a label;
a pop-up window;
a standard dialog;
a modal dialog;
a toolbar;
a scrollbar;
a task pane;
a menu bar; and
a menu item.

25. The data structure of claim 23, wherein the property for the element of the UI can include:
a shape;
a size;
a color;
a level of transparency;
a sound;
an event associated with the element of the UI;
a position;
a position relative to a second element of the UI; and
a visual effect.
